(19) United States
(12) Patent Application Publication
(10) Pub. No.: US 2022/0335746 A1
(43) Pub. Date: Oct. 20, 2022

(54) FINGERPRINT SENSING DEVICE

(71) Applicant: Egis Technology Inc., Hsinchu City (TW)

(72) Inventor: Shiue-Shin Liu, Hsinchu City (TW)

(73) Assignee: Egis Technology Inc., Hsinchu City (TW)

(21) Appl. No.: 17/634,245

(22) PCT Filed: Apr. 30, 2020
(86) PCT No.: PCT/CN2020/088080

§ 371 Date: Feb. 10, 2022

Related U.S. Application Data
(60) Provisional application No. 62/887,691, filed on Aug. 16, 2019.

(51) Int. Cl. G06V 40/13

(52) U.S. Cl. CPC G06V 40/1318

(57) ABSTRACT

A fingerprint sensing device, comprising an integrator circuit (102). The integrator circuit (102) performs integration operations on a plurality of sub-sensing signals in batches so as to accumulate sensing values of the plurality of sub-sensing signals and generate a sensing signal corresponding to each sensing pixel, wherein during a voltage setting period of a switch of the integrator circuit (102) and a capacitor circuit (106), an output terminal and a negative input terminal of a first amplifier (A1) are connected to each other, and the connection between a second capacitor (C2) and the negative input terminal and output terminal of the first amplifier (A1) is disconnected; and during the integration operation, the second capacitor (C2) is coupled between the negative input terminal and the output terminal of the first amplifier (A1) so as to perform the integration operation.

### BACKGROUND

### Technical Field

The invention relates to a sensing device, and in particular relates to a fingerprint sensing device.

### Description of Related Art

In recent years, the biological identification technology has developed rapidly. Since security codes and access cards are easily stolen or lost, the fingerprint identification technology attracts more attention. Fingerprints are unique and constant, and every person has multiple fingers for identification. Furthermore, a fingerprint sensor can be used to easily obtain a fingerprint. Therefore, the fingerprint identification can improve security and convenience, and can better protect financial security and confidential data.

Generally speaking, an optical fingerprint sensing device may include a panel, a light emitting source, an optical collimator, and a photoelectric sensor. An illumination light is provided to a finger pressing on the panel through the light emitting source. Then, an image light with fingerprint information is reflected via the panel and the finger object and is further transmitted to the photoelectric sensor via the optical collimator. Since the image light transmitted by the optical collimator is only a small portion of the reflected light, the optical collimator is generally provided with multiple lenses to transmit the image light to increase the sensing sensitivity and reduce the height of module to correspond to a sensing pixel. Although the sensitivity of fingerprint sensing can be effectively improved this way, since the number of signals to be processed is increased, the requirement for the data processing speed of the device for the subsequent signal processing is greatly increased, for example, a high-speed analog-to-digital converter needs to be provided, which greatly increases the product cost and power consumption.

### SUMMARY

The invention provides a fingerprint sensing device, which can effectively reduce production costs and power consumption.

A fingerprint sensing device of the invention includes a sensing pixel array, multiple integrator circuits, and a gain amplifier circuit. The sensing pixel array includes multiple sensing pixels, each of the sensing pixels includes multiple sub-sensing pixels, and each of the sub-sensing pixels senses a photoelectric signal including fingerprint information to generate a sub-sensing signal. The integrator circuits are coupled to the sensing pixel array and are respectively coupled to the corresponding sub-sensing pixels through multiple column signal lines and perform integration operation on the sub-sensing signals in batches to accumulate sensing values of the sub-sensing signals and generate a sensing signal corresponding to each of the sensing pixels. Each of the integrator circuits includes a first amplifier, a first capacitor, and a switch and capacitor circuit. A positive input terminal of the first amplifier is coupled to a first reference voltage. The first capacitor is coupled between a negative input terminal of the first amplifier and an output terminal of the corresponding integrator circuit. The switch and capacitor circuit includes a second capacitor and switches a connection state of the second capacitor, so that the corresponding integrator circuit periodically enters a voltage setting period and an integration operation period. During the voltage setting period, the switch and capacitor circuit connects an output terminal and the negative input terminal of the first amplifier and disconnects a connection between the second capacitor and the negative input terminal and the output terminal of the first amplifier, and during the integration operation period, the switch and capacitor circuit enables the second capacitor to be coupled between the negative input terminal and the output terminal of the first amplifier, so that the corresponding integrator circuit perform the integration operation. The gain amplifier circuit is coupled to the integrator circuit and amplifies the sensing signal to generate an amplification signal.

Based on the above, the integrator circuits in the embodiment of the invention may perform the integration operation on the sub-sensing signals in batches to accumulate the sensing values of the sub-sensing signals and generate the sensing signal corresponding to each of the sensing pixels. In this way, the number of the sensing signals that needs to be processed by a back-end circuit can be effectively reduced, so a circuit with high processing speed does not need to be provided, thereby effectively reducing the product cost and power consumption.

To make the aforementioned more comprehensible, several embodiments accompanied with drawings are described in detail as follows.

### BRIEF DESCRIPTION OF THE DRAWINGS

FIG. 1 is a schematic view of a fingerprint sensing device according to an embodiment of the invention;

FIG. 2 is a schematic view of a fingerprint sensing device according to another embodiment of the invention;

FIG. 3 is a waveform graph of signals of the fingerprint sensing device according to an embodiment of the invention.

### DESCRIPTION OF THE EMBODIMENTS

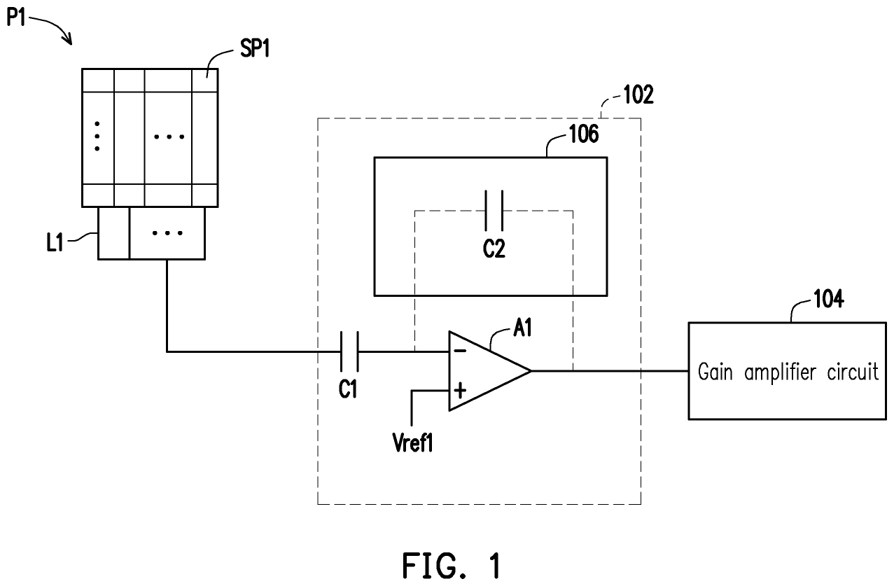

FIG. 1 is a schematic view of a fingerprint sensing device according to an embodiment of the invention. Please refer to FIG. 1. The fingerprint sensing device includes a sensing pixel P1, an integrator circuit 102, and a gain amplifier circuit 104. The integrator circuit 102 is coupled to the sensing pixel P1 and the gain amplifier circuit 104. It is worth noting that the number of the sensing pixel P1 and the number of the integrator circuit 102 included in the fingerprint sensing device are not limited to FIG. 1. For example, the fingerprint sensing device may include a sensing pixel array formed by multiple sensing pixels P1 and multiple integrator circuits 102, and each of the sensing pixels P1 may be coupled to the corresponding integrator circuit 102. In the embodiment, one sensing pixel P1 and one integrator circuit 102 are taken as examples to simplify the description.

As shown in FIG. 1, the sensing pixel P1 may include multiple sub-sensing pixels SP1, and a sub-sensing pixel array may be formed by the sub-sensing pixels SP1, such as an 8×8 sub-sensing pixel array, but the invention is not limited thereto. Each of the sub-sensing pixels SP1 may sense a photoelectric signal including fingerprint information to generate a sub-sensing signal. The integrator circuit 102 may be coupled to the sub-sensing pixels SP1 through multiple column signal lines L1 and may perform an integration operation on the sub-sensing signals in batches. For example, the integrator circuit 102 may perform the integration operation on a row of sub-sensing pixels SP1 at a time. After the integration operation of the sub-sensing pixels SP1 of each row is completed, that is, after the integration operation of the sensing pixel P1 is completed, an accumulated integration result is then transmitted to the gain amplifier circuit 104 to perform signal amplification processing to generate an amplification signal i for a back-end circuit to perform signal conversion and analysis processing.

Further specifically, the integrator circuit 102 may include, for example, an amplifier A1, a capacitor C1, and a switch and capacitor circuit 106. The capacitor C1 is coupled between a negative input terminal of the amplifier A1 and the integrator circuit 102, and a positive input terminal of the amplifier A1 is coupled to a reference voltage Vref1. The switch and capacitor circuit 106 may include a capacitor C2, and the capacitor C2 is coupled between the negative input terminal and an output terminal of the amplifier A1. The switch and capacitor circuit 106 may switch a connection state of the capacitor C2, so that the integrator circuit 102 periodically enters a voltage setting period and an integration operation period. During the voltage setting period, the switch and capacitor circuit 106 connects the output terminal and the negative input terminal of the amplifier A1 and disconnects a connection between the capacitor C2 and the negative input terminal and the output terminal of the amplifier A1. Also, during the integration operation period, the capacitor C2 is coupled between the negative input terminal and the output terminal of the amplifier A1, so that the corresponding integral circuit performs the integration operation. In this way, a voltage on the capacitor C1 may be reset during the voltage setting period without affecting the fingerprint information stored in the capacitor C2. Also, the capacitor C2 may accumulate the fingerprint information received during the integration operation period. After the integration operation of each of the sub-sensing pixels SP1 in the sensing pixel P1 is completed, the integration result is then transmitted to the gain amplifier circuit 104. Therefore, the back-end circuit with high data processing speed (such as a high-speed analog-to-digital converter) does not need to be provided as in the prior art to deal with the integration results of rows of the sub-sensing pixels SP1 row by row. Therefore, the production cost and power consumption of the fingerprint sensing device can be effectively reduced.

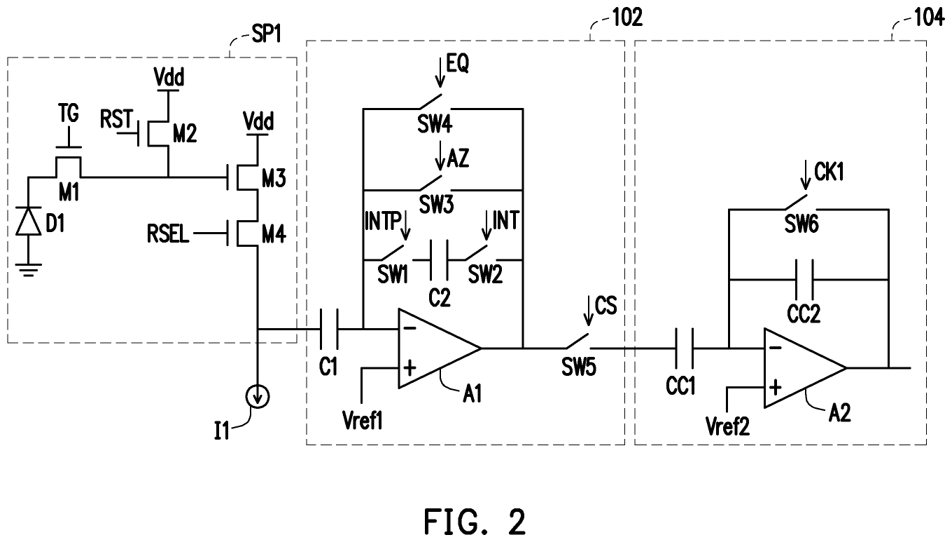

FIG. 2 is a schematic view of a fingerprint sensing device according to another embodiment of the invention. Please refer to the fingerprint sensing device in FIG. 1. In the embodiment, a single sub-sensing pixel SP1 is taken as an example to describe the implementation of the fingerprint sensing device. As shown in FIG. 2, the sub-sensing pixel SP1 may include a photoelectric conversion unit D1, a transmission transistor M1, a resetting transistor M2, an amplifying transistor M3, and a selecting transistor M4. The photoelectric conversion unit D1 may be, for example, a photodiode, and a positive pole and a negative pole of the photoelectric conversion unit D1 are respectively coupled to a first terminal of the transmission transistor M1 and a ground. A second terminal of the transmission transistor M1 is coupled to a control terminal of the amplifying transistor M3, and a control terminal of the transmission transistor M1 receives a transmission control signal TG. The resetting transistor M2 is coupled between an operation voltage Vdd and the control terminal of the amplifying transistor M3, and a control terminal of the resetting transistor M2 receives a reset control signal RST. A first terminal and a second terminal of the amplifying transistor M3 are respectively coupled to the operation voltage Vdd and a first terminal of the selecting transistor M4, a second terminal of the selecting transistor M4 is coupled to the capacitor C1 and a current source I1, and a control terminal of the selecting transistor M4 is coupled to a selection control signal RSEL.

Furthermore, the switch and capacitor circuit 106 of the integrator circuit 102 includes switches SW1 to SW5 and the capacitor C2. The switch SW1 is coupled between the negative input terminal of the amplifier A1 and the capacitor C2, the switch SW2 is coupled between the output terminal of the amplifier A1 and the capacitor C2, the switch SW3 and the switch SW4 are coupled between the negative input terminal and the output terminal of the amplifier A1, and the switch SW5 is coupled between the output terminal of the amplifier A1 and an input terminal of the gain amplifier circuit 104. Besides, the gain amplifier circuit 104 includes a switch SW6, capacitors CC1 and CC2, and an amplifier A2. The capacitor CC1 is coupled between a negative input terminal of the amplifier A2 and the switch SW5, a positive input terminal of the amplifier A2 is coupled to a reference voltage Vref2, and the switch SW6 and the capacitor C2 are coupled between the negative input terminal and an output terminal of the amplifier A2.

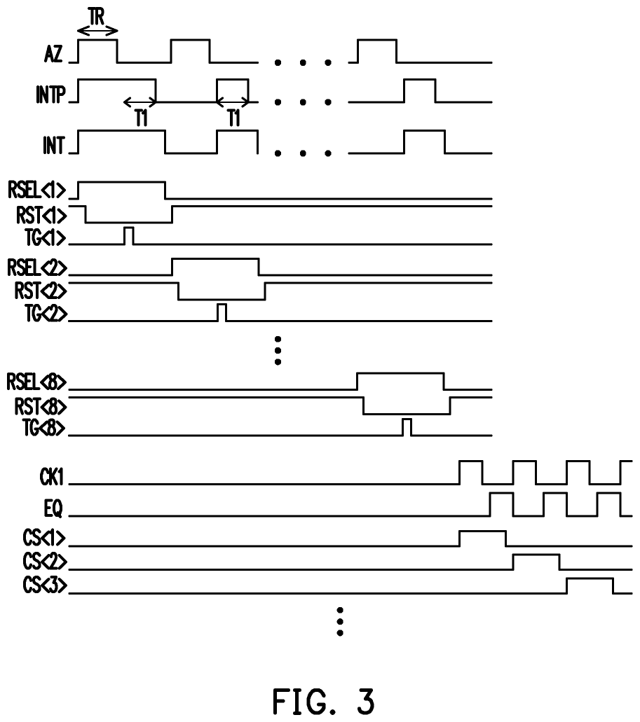

FIG. 3 is a waveform graph of signals of the fingerprint sensing device according to an embodiment of the invention. In FIG. 3, RSEL<n>, RST<n>, and TG<n> respectively represent the selection control signal RSEL, the reset control signal RST, and the transmission control signal TG corresponding to the sub-sensing pixel SP1 in an n-th row. CS<m> represents a column selection signal CS corresponding to the sensing pixel P1 in an m-th column. The selection control signal RSEL, the reset control signal RST, the transmission control signal TG, and the column selection signal CS are used below to illustrate a manner of processing the sub-sensing signals of the sub-sensing pixel SP1 in the n-th row of the sensing pixel P1 in the m-th column, where m and n are positive integers. In the embodiment, the maximum value of n is 8, but the invention is not limited thereto. Please refer to FIG. 2 and FIG. 3 together. As shown in FIG. 3, the resetting transistor M2 may be controlled by the reset control signal RST to reset a voltage of the control terminal of the amplifying transistor M3 according to the operation voltage. At this time, the switch SW3 is controlled by a control signal AZ and is conducted during a voltage setting period TR to reset a voltage of the capacitor C1. When the row of the sub-sensing pixel SP1 is selected to output the sub-sensing signals, the selecting transistor M4 may be controlled by the selection control signal RSEL and is thereby conducted. Next, the transmission transistor M1 is controlled by the transmission control signal and is conducted to transmit a photoelectric conversion signal obtained by converting a photoelectric signal including the fingerprint information by the photoelectric conversion unit D1 to, to the control terminal of the amplifying transistor M3, so that the conduction degree of the amplifier transistor M3 is changed according to the photoelectric conversion signal, thereby transmitting the fingerprint information to the capacitor C1 through the selecting transistor M4. At this time, the switches SW1 and SW2 are controlled by control signals INTP and INT to enter the conducting state during an integration operation period T1 to perform the integration operation, and the fingerprint information is stored in the capacitor C2. During the integration operation period T1, the switch SW3 is controlled by the control signal AZ and is in a disconnected state.

It is worth noting that when each of the sensing pixels P1 enters the voltage setting period TR for the first time, that is, when the voltage of the capacitor C1 is reset for the first time, the switches SW1 and SW2 are also controlled by the control signals INTP and INT to enter the conducting state to delete the fingerprint information of the last sensing pixel P1 stored in the capacitor C2. In other words, during a signal processing period of the sub-sensing signals of each of the sensing pixels P1, except for the first voltage setting period TR, the switches SW1 and SW2 are both in the disconnected state during the remaining voltage setting periods TR, so that the accumulated integration result may be prevented from being reset. In addition, after each integration operation period ends, the switches SW1 and SW2 enter the disconnected state before entering the next voltage setting period TR, and the capacitor C2 is prevented from being reset during the next voltage setting period TR. In the embodiment, the switch SW1 is enabled to enter the disconnected state earlier than the switch SW2. Since the switch SW1 is coupled to the negative input terminal of the amplifier A1, and the negative input terminal of the amplifier A1 has the characteristic of virtual grounding, the switch SW1 is disconnected first to prevent the fingerprint information stored in the capacitor C2 from being distorted due to the influence of switching action of the switch SW1.

After the integration operation of each row of the sub-sensing pixels SP1 in the sensing pixel P1 is completed, the switch SW5 is controlled by the column selection signal CS to be conducted, while the switch SW6 is also controlled by a control signal CK1 to be conducted to reset voltages of the capacitor CC1 and the capacitor CC2. Then, the switch SW6 is controlled by the control signal CK1 to be disconnected, the switch SW5 enters the disconnected state later than the switch SW6, and the switch SW4 is controlled by a control signal EQ and enters the conducting state after the switch SW6 is disconnected and before the switch SW5 is disconnected to transmit a voltage (which includes the accumulated integration result, that is, the sensing signal obtained by sensing the photoelectric signal by the sensing pixel P1) of the negative input terminal of the amplifier A1 to the capacitor CC1 to perform the signal amplification processing, and an amplification signal is output from the output terminal of the amplifier A2 to the back-end circuit to perform the signal conversion and analysis processing. The time point when the switch SW4 enters the disconnected state may be, for example, before the switch SW6 enters the conducting state the next time, that is, before the gain amplifier circuit 104 performs the signal amplification processing of the sensing signal of another sensing pixel P1, the switch SW4 enters the disconnected state.

In summary, the integrator circuit in the embodiment of the invention may perform the integration operation on the sub-sensing signals in batches to accumulate the sensing values of the sub-sensing signals and generate the sensing signal corresponding to each of the sensing pixels. In this way, the number of the sensing signals that needs to be processed by the back-end circuit can be effectively reduced, and a circuit with high processing speed does not need to be provided, thereby effectively reducing the product cost and power consumption.

It will be apparent to those skilled in the art that various modifications and variations can be made to the disclosed embodiments without departing from the scope or spirit of the disclosure. in view of the foregoing, it is intended that the disclosure covers modifications and variations provided that they fall within the scope of the following claims and their equivalents.

What is claimed is:

1. A fingerprint sensing device, comprising:
a sensing pixel array, comprising a plurality of sensing pixels, wherein each of the sensing pixels comprises a plurality of sub-sensing pixels, and each of the sub-sensing pixels senses a photoelectric signal comprising fingerprint information to generate a sub-sensing signal;
a plurality of integrator circuits, coupled to the sensing pixel array, respectively coupled to the corresponding sub-sensing pixels through a plurality of column signal lines, and perform an integration operation on the sub-sensing signals in batches to accumulate sensing values of the sub-sensing signals and generate a sensing signal corresponding to each of the sensing pixels, wherein each of the integrator circuits comprises:
a first amplifier, wherein a positive input terminal of the first amplifier is coupled to a first reference voltage;
a first capacitor, coupled between a negative input terminal of the first amplifier and an output terminal of the corresponding integrator circuit; and
a switch and capacitor circuit, comprising a second capacitor and switching a connection state of the second capacitor, so that the corresponding integrator circuit periodically enters a voltage setting period and an integration operation period, wherein during the voltage setting period, the switch and capacitor circuit connects an output terminal and the negative input terminal of the first amplifier and disconnects a connection between the second capacitor and the negative input terminal and the output terminal of the first amplifier, and during the integration operation period, the switch and capacitor circuit enables the second capacitor to be coupled between the negative input terminal and the output terminal of the first amplifier, so that the corresponding integrator circuit performs the integration operation; and
a gain amplifier circuit, coupled to the integrator circuits and amplifying the sensing signal to generate an amplification signal.

2. The fingerprint sensing device according to claim 1, wherein the switch and capacitor circuit further comprises:
a first switch, coupled between a terminal of the second capacitor and the negative input terminal of the first amplifier; and
a second switch, coupled between another terminal of the second capacitor and the output terminal of the first amplifier, wherein after each integration operation period ends, the first switch and the second switch enter a disconnected state before entering the voltage setting period.

3. The fingerprint sensing device according to claim 2, wherein the first switch enters the disconnected state earlier than the second switch.

4. The fingerprint sensing device according to claim 2, wherein each of the integrator circuits further comprises:
a third switch, coupled between the negative input terminal and the output terminal of the first amplifier, being in a conducting state during the voltage setting period, and being in the disconnected state during the integration operation period.

5. The fingerprint sensing device according to claim 4, wherein the first switch and the second switch are in the conducting state during a first voltage setting period of each of the sensing pixels and are in the disconnected state during a remaining voltage setting period of each of the sensing pixels.

6. The fingerprint sensing device according to claim 1, wherein the gain amplifier circuit comprises:
a second amplifier, wherein a positive input terminal of the second amplifier is coupled to a second reference voltage;
a third capacitor, coupled between the output terminals of the integrator circuits and the positive input terminal of the second amplifier; and
a fourth capacitor, coupled between a negative input terminal of the second amplifier and an output terminal of the second amplifier.

7. The fingerprint sensing device according to claim 6, wherein each of the integrator circuits further comprises:
a first switch, coupled between the output terminals of the integrator circuits and an input terminal of the gain amplifier circuit, and controlled by a column selection signal to output the sensing signal.

8. The fingerprint sensing device according to claim 7, wherein the gain amplifier circuit further comprises:
a second switch, coupled between the negative input terminal and the output terminal of the second amplifier, simultaneously conducted with the first switch, and entering a disconnected state earlier than the first switch.

9. The fingerprint sensing device according to claim 8, wherein each of the integrator circuits further comprises:
a third switch, coupled between the negative input terminal and the output terminal of the first amplifier and entering a conducting state after the second switch is disconnected and before the first switch is disconnected.

10. The fingerprint sensing device according to claim 1, wherein each of the sub-sensing pixels comprises:
a photoelectric conversion unit, converting the photoelectric signal to generate a photoelectric conversion signal;
a transmission transistor, wherein a first terminal of the transmission transistor is coupled to the photoelectric conversion unit, and the transmission transistor is controlled by a transmission control signal to output the photoelectric conversion signal;
a resetting transistor, wherein a first terminal of the resetting transistor is coupled to an operation voltage, a second terminal of the resetting transistor is coupled to a second terminal of the transmission transistor, and the resetting transistor is controlled by a reset control signal to reset a voltage of the second terminal of the transmission transistor;
an amplifying transistor, wherein a control terminal of the amplifying transistor is coupled to the second terminal of the transmission transistor, a first terminal of the amplifying transistor is coupled to the operation voltage to generate the sub-sensing signals in response to a voltage value of the photoelectric conversion signal; and
a selecting transistor, coupled to a second terminal of the amplifying transistor and an input terminal of the corresponding integrator circuit and controlled by a selection control signal to output the sub-sensing signals on the corresponding integrator circuit.
